(19) United States
(12) Patent Application Publication
(10) Pub. No.: US 2009/0300132 A1
(43) Pub. Date: Dec. 3, 2009

(54) COMPUTER OPERATION SYSTEM AND COMPUTER OPERATION METHOD

(75) Inventor: Wakami Hoshino, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/472,530

(22) Filed: May 27, 2009

(30) Foreign Application Priority Data
May 30, 2008 (JP) 2008-142840

(51) Int. Cl. G06F 15/16

(52) U.S. Cl. 709/208

(57) ABSTRACT

One operation unit is connected to plural personal computers via a network. The operation unit operates the personal computers on the basis of the IP address of each of the personal computers.

### CROSS-REFERENCE TO RELATED APPLICATION

This application is based upon and claims the benefit of priority from prior Japanese Patent Application No. 2008-142840, filed May 30, 2008, the entire contents of which are incorporated herein by reference.

### TECHNICAL FIELD

The present invention relates to a computer operation system and a computer operation method for operating plural computers.

### BACKGROUND

In a system (for example, JP-A-2004-78359) including plural client computers connected to one print server via a network, as a technique of operating the plural computers from the server side, each computer is connected with the server by wiring and the wires are selectively electrically connected by a switcher so as to send a control signal. There is also an example where remote operation software such as Virtual Network Computing (VNC) is loaded in the server.

As described above, in the method in which the wire between each computer and the server is selectively electrically connected by the switcher, the number of wires must be increased if a large number of computers exist. Thus, there is a problem that the wiring becomes complicated and obstructive.

Meanwhile, in the example where remote operation software is loaded in the server, the server needs to have advanced specifications enough to utilize the remote operation software, posing a problem that the cost is increased by the need of advanced specifications.

### SUMMARY

It is an object of the invention provide a computer operation system and a computer operation method that enable simple and easy operation of each computer without requiring complicated wiring and without causing an increase in cost even if there are a large number of computers.

A computer operation system according to an aspect of the invention includes: plural computers each of which has unique information defined for itself; and one operation unit which is connected to these computers via a network and executes operation to each of the computers on the basis of the information unique to each computer.

### DESCRIPTION OF THE DRAWINGS

The accompanying drawings, which are incorporated in and constitute a part of the specification, illustrate embodiment of the invention, and together with the general description given above and the detailed description of the embodiment given below, serve to explain the principles of the disclosure.

FIG. 1 is a block diagram showing the configuration of an embodiment of the invention.

FIG. 2 is a flowchart for explaining an effect of the embodiment.

FIG. 3 is a block diagram showing the configuration of a modification of the embodiment.

### DETAILED DESCRIPTION

Hereinafter, an embodiment of the invention will be described with reference to the drawings.

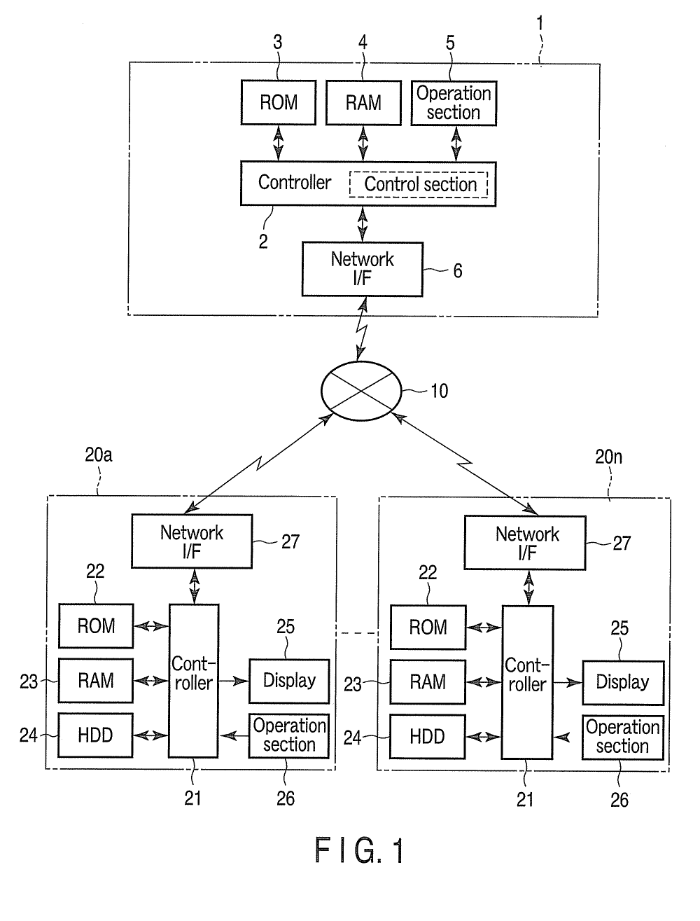

As shown in FIG. 1, one operation unit 1 and plural personal computers (PC) 20a, 20b, . . . 20n are connected to each other via a communication network 10. A computer operation system is formed by this connection.

The operation unit 1 includes a controller 2, a ROM 3, a RAM 4, an operation section 5 such as a keyboard, and a network interface (I/F) 6 for network connection. In the ROM 3, predetermined IP addresses are stored as information unique to each of the personal computers 20a, 20b, . . . 20n.

The personal computers 20a, 20b, . . . 20n include a controller 21, a ROM 22 for storing a control program, a RAM 23 for storing data, a hard disk drive (HDD) 24 for storing data, a display 25, an operation section 26, and a network interface (I/F) 27 for network connection.

The controller 2 of the operation unit 1 includes a control section described in the following (1), as its main function.

(1) The control section executes operation to the personal computers 20a, 20b, . . . 20n in accordance with the operation of the operation section 5 and on the basis of each IP address in the ROM 3.

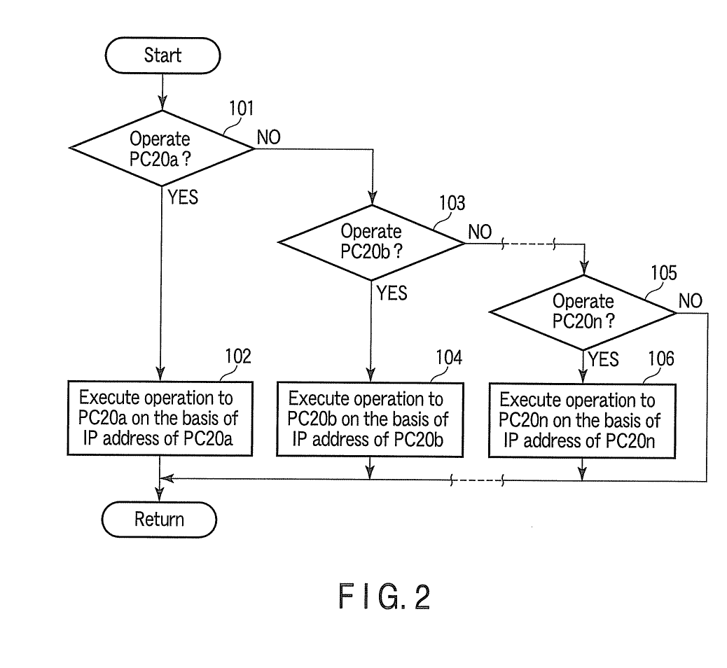

Next, the actions will be described with reference to the flowchart of FIG. 2.

As an operation condition for the personal computer 20a is set by the operation section 5 of the operation unit 1 (YES in Act 101), an operation command corresponding to the set operation condition is transmitted to the personal computer 20a from the operation unit 1 on the basis of the IP address unique to the personal computer 20a. Thus, the operation to the personal computer 20a is executed (Act 102).

As an operation condition for the personal computer 20b is set by the operation section 5 of the operation unit 1 (YES in Act 103), an operation command corresponding to the set operation condition is transmitted to the personal computer 20b from the operation unit 1 on the basis of the IP address unique to the personal computer 20b. Thus, the operation to the personal computer 20b is executed (Act 104).

As an operation condition for the personal computer 20n is set by the operation section 5 of the operation unit 1 (YES in Act 105), an operation command corresponding to the set operation condition is transmitted to the personal computer 20n from the operation unit 1 on the basis of the IP address unique to the personal computer 20n. Thus, the operation to the personal computer 20n is executed (Act 106).

As such operation, batch operation to plural personal computers can be carried out as well as a single operation to one of the personal computers 20a, 20b, . . . 20n.

Since the one operation unit 1 is thus connected to the plural personal computers 20a, 20b, . . . 20n via a network, it is not necessary to provide many wires and a switcher between the personal computers 20a, 20b, . . . 20n and the operation unit 1. Even if a large number of personal computers 20a, 20b, . . . 20n exist, complicated wiring is not needed.

Moreover, the operation unit 1 only has to perform simple control of operating the personal computers 20a, 20b, . . . 20n on the basis of the IP addresses of the personal computers 20a, 20b, . . . 20n, and advanced specifications as in the conventional case of using remote operation software are not necessary. Therefore, the personal computers 20a, 20b, . . . 20n can be simply and easily operated without causing increase in cost.

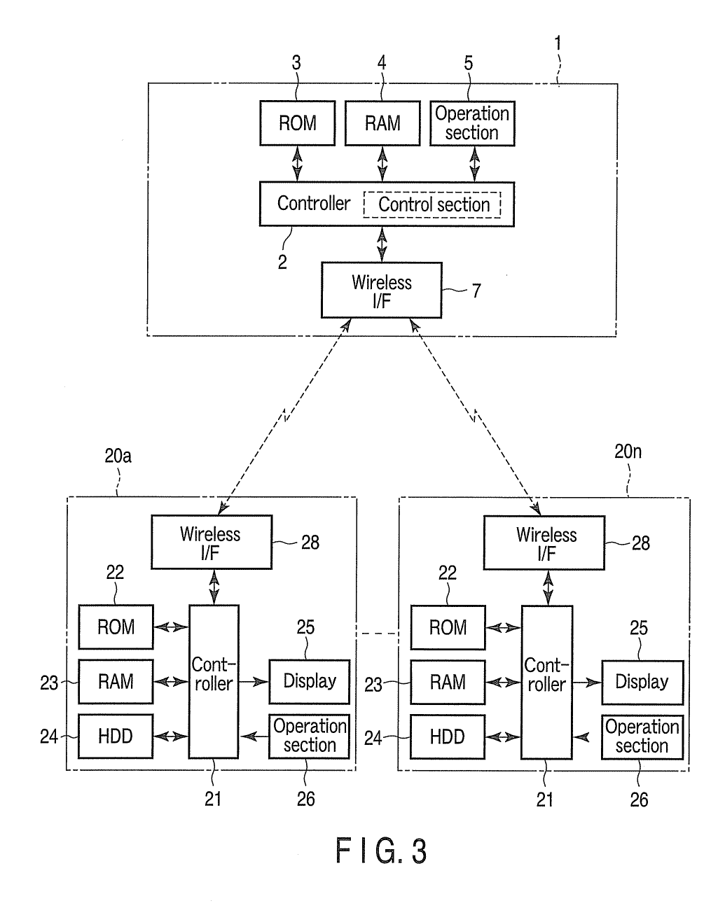

Alternatively, a wireless interface 7 for wireless communications may be provided instead of the network interface 6 of the operation unit 1, and a wireless interface 28 for wireless communications may be provided instead of the network interface 27 of each of the personal computers 20a, 20b, . . . 20n, so that the personal computers 20a, 20b, . . . 20n may be operated by wireless communications from the operation unit 1, as shown in FIG. 3.

Also, while an IP address is used as information unique to each of the personal computers 20a, 20b, . . . 20n in the embodiment, such unique information is not limited to an IP address and other identification codes may be used.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A computer operation system comprising:
plural computers each of which has unique information defined for itself; and
one operation unit which is connected to these computers via a network and executes operation to each of the computers on the basis of the information unique to each computer.

2. The system according to claim 1, wherein each of the computers and the operation unit include a network interface for network connection.

3. The system according to claim 1, wherein each of the computers and the operation unit include a wireless interface for wireless communications.

4. A computer operation method for operating plural computer each of which has unique information defined for itself, the method comprising:
connecting one operation unit to each of the computers via a network; and
executing operation to each of the computers on the basis of the information unique to each computer, by the operation unit.

5. The method according to claim 4, wherein each of the computers and the operation unit include one of a network interface for network connection and a wireless interface for wireless communications.
